(19) United States
(12) Patent Application Publication
(10) Pub. No.: US 2007/0088635 A1
(43) Pub. Date: Apr. 19, 2007

(54) Determining policy compliance based on existing compliance results

(76) Inventor: Jonathan B. King, Bluffdale, UT (US)

Correspondence Address: SYMANTEC CORPORATION C/O WORKMAN NYDEGGER;ADRIAN J. LEE, 1000 EAGLE GATE TOWER, 60 EAST SOUTH TEMPLE, SALT LAKE CITY, UT, 84111, US

(21) Appl. No.: 11/238,301

(22) Filed: Sep. 29, 2005

(51) Int. Cl. G07F 19/00

(52) U.S. Cl. 705/30

(57) ABSTRACT

The application of compliance results from at least a portion of one policy to one or more additional policies that are different from the first policy without having to run compliance checks for the one or more additional policies. The policies consist of compliance checks that each have one or more arguments indicating compliance conditions associated with them. When data is subjected to the compliance checks of the first policy, compliance results are produced corresponding to each compliance check and its associated arguments. A unique identifier is created that represents a combination of both a compliance check and its associated arguments of the first policy. The unique identifier is then associated with the compliance result corresponding to the compliance check and its associated arguments that make up the unique identifier. The compliance result associated with the unique identifier is then applied to a second policy.

### CROSS-REFERENCE TO RELATED APPLICATIONS

Not applicable.

### BACKGROUND OF THE INVENTION

Computing technology has revolutionized the way people work and play and has contributed enormously to the advancement of humankind. Computers now aid in enumerable applications such as word processing, computer simulations, advanced gaming, voice recognition, among much more. Computing systems now come in a wide-variety of forms including, for example, desktop computers, laptop computers, Personal Digital Assistants (PDAs), and even mobile telephones and devices.

One common use of computing systems by various businesses, government agencies, and other users is the storage of important confidential or otherwise critical data. For example, a doctor's office may use a computing system to store patient health and insurance records or a stock brokerage firm may use a computing system to store confidential financial records. In addition, computing systems are also used for record keeping in a prescribed manner, such as corporate record keeping.

In recent years, as the amount of confidential or critical data stored on computers has increased, there has been an increased emphasis on making sure that this data is secure or that the proper data has been recorded. Congress and other governmental agencies have passed various policies regarding the safekeeping of the stored critical data or the collecting of required data. For example, the Federal Information Security Management Act (FISMA) sets polices for data security. The Health Insurance Portability and Accountability Act (HIPAA) sets policies for the security of health and insurance records. The Sarbanes-Oxley Act set polices for corporate record keeping and other corporate activities. The Gramm-Leach-Bliley Act (GLBA) sets privacy policies for banks and other financial institutions.

The introduction of these and other policies has led to the corresponding development of policy compliance software. Policy compliance software typically consists of a set of checks that are performed on a computing system to verify whether the requirements of an underlying policy have been complied with. Most checks include arguments that function as compliance conditions. For example, to ensure patient record safety, HIPAA may require that a password for access to the records be a minimum length. In this case, the check for minimum password length would include an argument that specifies the number of characters to compare the password against. If a user's password consisted of fewer characters than the minimum, the check would generate a failure message. Other requirements of the policy are also verified for compliance using other checks and their associated arguments.

Running all the required policy compliance checks for a given policy can be time consuming and costly. It typically takes a large amount of computing resources to run a large number of policy checks, especially when the policy checks have multiple arguments. Often, the computing system is not able to perform other tasks while performing a policy compliance check.

Unfortunately, most policy compliance check software only allow a single policy compliance check to be performed at a time. For example, if a user needs to run compliance checks for HIPAA and FISMA, then the user would have to run one compliance check first, followed by the other. This increases the pressure on the computing system resources.

In recent years, some policy compliance software has attempted to allow the sharing of results among different policies. For example, one product gathers data about everything in a policy that can be checked such as user setting and registries. This data is put into a database and checked directly to determine compliance. A different policy can use the gathered data for a compliance check.

However, this product still requires that checks be run against the database. This may not always be efficient as some checks may need to be performed daily while others may only need to be performed weekly or monthly. For example, a password compliance check may need to be more frequently run than other types of compliance checks.

Accordingly, what would be advantageous is a policy compliance product that allows multiple policies to use results from one policy compliance check without the need to always run the entire compliance check.

### BRIEF SUMMARY OF THE INVENTION

The forgoing problems with the prior state of the art are overcome by the principles of the present invention, which relate to the application of compliance results from at least a portion of one policy to one or more additional policies that are different from the first policy without having to run a compliance check for the one or more additional policies. The policies consist of compliance checks that each have one or more arguments associated with them. The arguments specify compliance conditions that are indicative of compliance with the policy. When data is subjected to the compliance checks of the first policy, compliance results are produced corresponding to each compliance check and its associated arguments.

A unique identifier is created that represents a combination of both a compliance check and its associated arguments of the first policy. The unique identifier is then associated with the compliance result corresponding to the compliance check and its associated arguments that make, up the unique identifier. The compliance result associated with the unique identifier is then applied to a second policy that has a compliance check where its associated arguments match the compliance check and its associated arguments representing the unique identifier. Accordingly, the computing resources associated with performing compliance checks may be conserved.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a suitable computing system in which the principles of the present invention may be implemented;

FIG. 2 illustrates an overview schematic of a series of data flows for a compliance result from a first policy to be applied to a second policy in accordance with one embodiment of the present invention;

FIG. 3 illustrates a flowchart of method for a compliance result from a first policy to be applied a second policy in accordance with the principles of the present invention;

FIG. 4 illustrates a flowchart of a method for compliance results from a plurality of sub-policies to be combined into a compliance result for a first policy in accordance with the principles of the present invention;

FIG. 5 illustrates a flowchart of a method for a second policy to apply compliance results from a first policy in accordance with the principles of the present invention; and

FIG. 6 illustrates a flowchart of a method for creating a unique identifier for a policy in accordance with the principles of the present invention.

### DETAILED DESCRIPTION OF THE PREFERRED EMBODIMENTS

The principles of the present invention relate to the application of compliance results from at least a portion of one policy to one or more additional policies that are different from the first policy without having to run a compliance check for the one or more additional policies. Turning to the drawings, wherein like reference numerals refer to like elements, the principles of the present invention are illustrated as being implemented in a suitable computing system. The following description is based on illustrated embodiments of the invention and should not be taken as limiting the invention with regard to alternative embodiments that are not explicitly described herein.

In the description that follows, embodiments of the invention are described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the principles of the invention are being described in the foregoing context, it is not meant to be limiting as those of skill in the art will appreciate that several of the acts and operations described hereinafter may also be implemented in hardware.

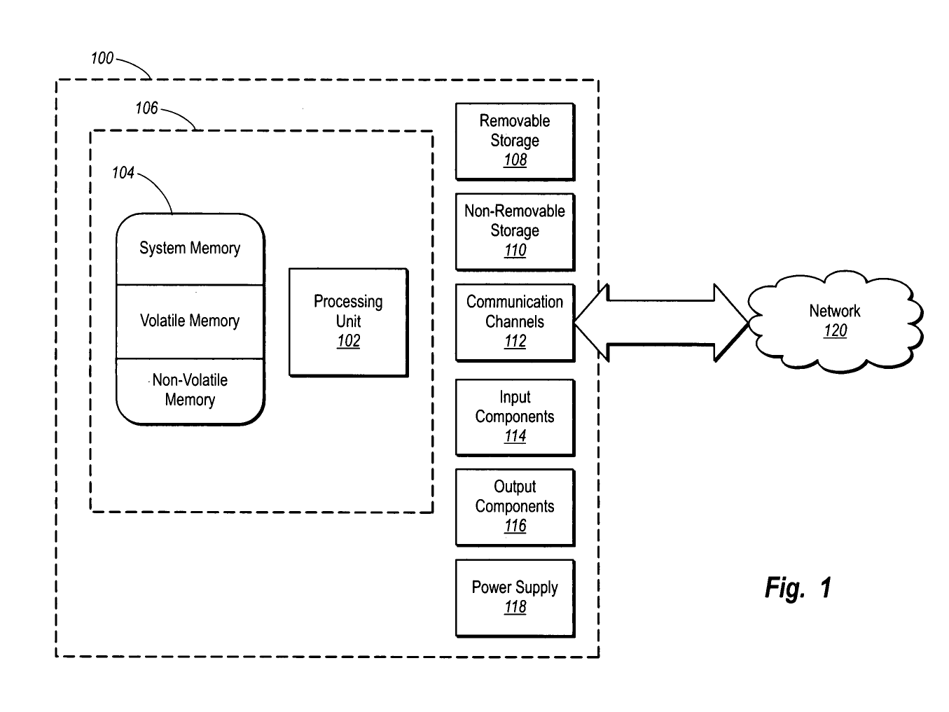

FIG. 1 shows a schematic diagram of an example computer architecture usable for these devices. For descriptive purposes, the architecture portrayed is only one example of a suitable environment and is not intended to suggest any limitation as to the scope of use or functionality of the invention. Neither should the computing systems be interpreted as having any dependency or requirement relating to any one or combination of components illustrated in FIG. 1.

The principles of the present invention are operational with numerous other general-purpose or special-purpose computing or communications environments or configurations. Examples of well-known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing system 100 typically includes at least one processing unit 102 and memory 104. The memory 104 may be volatile (such as RAM), non-volatile (such as ROM, flash memory, etc.), or some combination of the two. This most basic configuration is illustrated in FIG. 1 by the dashed line 106.

The storage media devices may have additional features and functionality. For example, they may include additional storage (removable and non-removable) including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing system.

As used herein, the term “module” or “component” can refer to software objects or routines that execute on the computing system. The different components, modules, engines, and services described herein may be implemented as objects or processes that execute on the computing system (e.g., as separate threads). While the system and methods described herein may be implemented in software, implementations in software and hardware or hardware are also possible and contemplated.

Computing system 100 may also contain communication channels 112 that allow the host to communicate with other systems and devices over, for example, network 120. Although the network 120 may include any network type (whether now existing or to be developed in the future), examples include Token Ring, Ethernet, Bluetooth, 802.11, USB, 1394, SMS, SOAP over IP, or the like. Communication channels 112 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media. Computing system 100 may extend beyond a single computational node to utilize the network for distributed processing.

The computing system 100 may also have input components 114 such as a keyboard, mouse, pen, a voice-input component, a touch-input device, and so forth. Output components 116 include screen displays, speakers, printer, etc., and rendering modules (often called “adapters”) for driving them. The computing system 100 has a power supply 118. All these components are well known in the art and need not be discussed at length here.

While FIG. 1 represents a suitable operating environment for the present invention, the principles of the present invention may be employed in any computing system. The computing system illustrated in FIG. 1 is illustrative only, and by no means represents even a small portion of the wide, variety of environments in which the principles of the present invention may be implemented. In the description and in the claims, a “computing system” is defined broadly as any hardware component or components that are capable of using software to perform one or more functions. Examples of computing systems include, but are not limited to, desktop computers, laptop computers, Personal Digital Assistants (PDAs), telephones, or any other system or device that has processing capability.

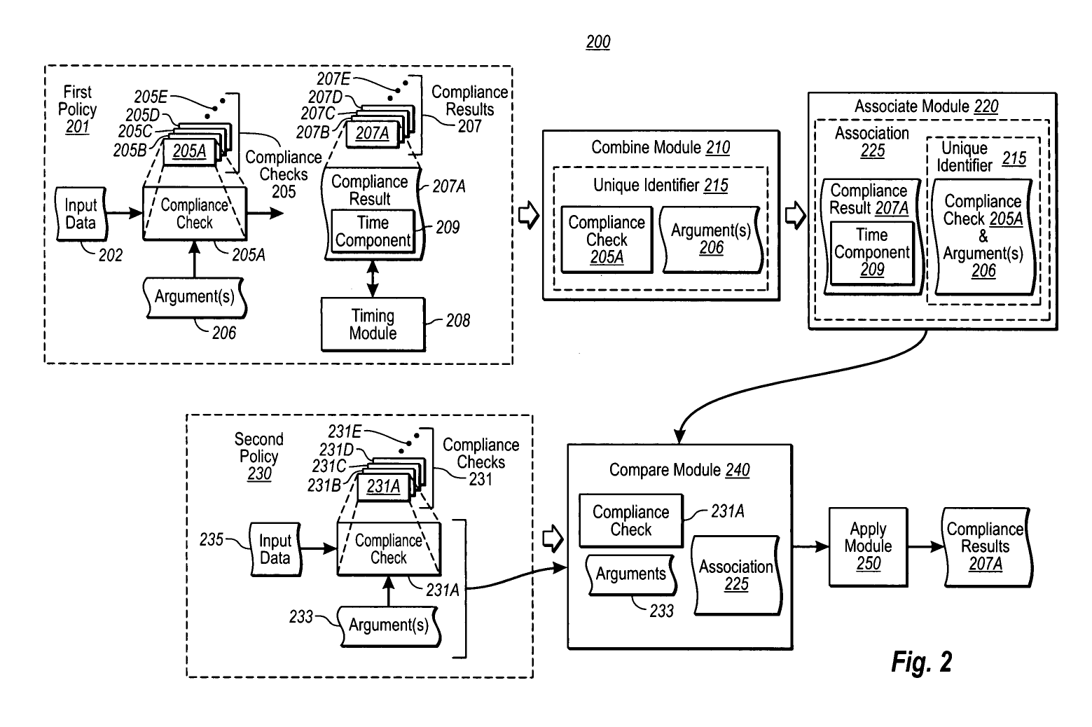

FIG. 2 illustrates an overview schematic 200 of a series of data flows for applying a compliance result from a first policy to one or more additional policies in accordance with the principles of the present invention. Schematic 200 depicts various modules and components of a computing system, such as, for example, computing system 100 of FIG. 1, that can be used when implementing the principles of the present invention. Schematic 200 is illustrated by way of example only and should not be used to limit the scope of the appended claims. It will be obvious to one of ordinary skill in the art after having read this description that there are numerous other ways to implement the principles of the present invention.

Schematic 200 depicts a first policy 201. In general, a policy is a set of rules that dictate standards for judging compliance. Such standards may dictate, for example, but are not limited to, the safekeeping of stored critical data or the collecting of required data. In a computing system, a policy consists of a number of compliance checks and associated arguments that are used to verify compliance with the rules of the underlying policy. Examples of well known policies include the Federal Information Security Management Act (FISMA), which sets polices for data security, the Health Insurance Portability and Accountability Act (HIPAA), which sets policies for the security of health and insurance records, the Sarbanes-Oxley Act, which set polices for corporate record keeping and other corporate activities, and the Gramm-Leach-Bliley Act (GLBA), which sets privacy policies for banks and other financial institutions. There are also any number of additional policies that may be subjected to policy compliance checks. However, this non-exhaustive list is provided for illustrative purpose only.

First policy 201 includes a plurality of compliance checks 205A, 205B, 205C, and 205D. There can also be any number of additional compliance checks as represented by ellipses 205E. Furthermore, a policy may include fewer than four compliance checks, or even one. Compliance checks 205A through 205E may also be referred to herein collectively as “compliance checks 205”.

Compliance checks 205 are performed by the computing system to verify whether the requirements of an underlying policy have been complied with. For example, to ensure patient record safety, HIPAA may require that a password for access to the records be a minimum length and contain only certain characters. In addition, HIPAA may require that only specified individuals be allowed access to the records, for example a state-licensed medical doctor or nurse. To verify compliance with these HIPAA requirements, compliance check 205A may be configured to check compliance with a required minimum password length and allowed characters. In addition, compliance check 205B may be configured to check compliance with the specified individuals who are allowed access. Compliance checks 205C, 205D and potentially 205E may be configured to verify other requirements of the underlying policy.

Compliance checks 205 each have associated with them one or more arguments. In FIG. 2, one or more arguments 206 are shown as being associated with compliance check 205A while arguments associated with compliance checks 205B, 205C, 205D, and potentially 205E are not illustrated. Although arguments 206 may include any positive integer number of arguments, or in some embodiments zero arguments, arguments 206 may be referred hereinafter simply as “argument 206” for simplicity.

Argument 206 and the arguments associated with the other compliance checks 205 provide compliance conditions for the associated compliance check. For example, if compliance check 205A is configured to check compliance with a required minimum password length and allowable password characters as described previously, then an individual argument of argument 206 would specify the minimum acceptable password length. In addition, an individual argument of argument 206 would specify the set of allowable password characters. Furthermore, if compliance check 205B is configured to check compliance with the specified individuals who are allowed access to a group of records, then an argument (not illustrated) associated with compliance check 205B would provide the names of those individuals allowed access such as, for example, the name of the doctor and the nurse authorized to access.

Input data, such as input data 202, can be input into each compliance check 205 for verification of the underlying policy. The compliance checks 205 compare the input data against their associated arguments using the compliance check logic to produce compliance results 207. Compliance results 207 are indicative of compliance with the underlying policy requirement. In FIG. 2, compliance result 207A is illustrated as corresponding to compliance check 205A, while compliance results 207B, 207C, 207D, and potentially 207E (as illustrated by ellipses 207E) correspond to compliance checks 205B, 205C, 205D and 205E respectively. The compliance results may be single data structure or multiple interrelated data structures.

For example, input data 202 may be input into compliance check 205A. In this case, input data 202 can be a password that is a certain length and consists of certain characters. Compliance check 205A compares the input password (input data 202) against arguments 206 that specify the minimum allowed password length and allowable password characters as described previously. If the password satisfies both the minimum length and allowable character requirements of the underlying policy (e.g., HIPAA), then compliance check 205A generates a compliance result 207A signifying that the check was successful. On the other hand, if the password does not satisfy the minimum length and/or allowable character requirements of the underlying policy, then compliance check 205A generates a compliance result 207A signifying that the check was unsuccessful.

Similarly, other input data (not illustrated) may be input into compliance check 205B. In this case, input data 202 can be the name of an individual wanting access to records stored on the computing system, and potentially also there security and/or licensing information. Compliance check 205B compares the input against arguments that specify names of individuals allowed to access the records as described previously, or perhaps also verifies the security and/or licensing information. If the input satisfies the allowed individual requirements of the underlying policy (e.g., HIPAA), then compliance check 205B generates a compliance result 207B signifying that the check was successful. On the other hand, if the input does not satisfy the allowed individual requirements of the underlying policy (for example, the name does not match a list of authorized users, or perhaps the user does not hold the required license), then compliance check 205B generates a compliance result 207B signifying that the check was unsuccessful.

In some embodiments, first policy 201 can have associated therewith a timing module 208. Timing module 208 can be software, hardware, or a combination of both software and hardware and is configured to specify the age of a compliance result by, for example time stamping the results. Specifying the age of a compliance result is helpful to ensure that the compliance result is not outdated when subsequently being applied to another policy such as, for example, using the principles of the present invention described further herein. For example, suppose a compliance check 205A was run on a password and a compliance result 207A was produced as previously described. Further suppose that subsequent to the compliance result 207A being produced, the password was changed. This would result in the compliance result 207A becoming outdated. However, timing module 208 can be used to add a time component 209 to the compliance result, as is illustrated in FIG. 2. Timing component 209 can be used (along with the current time) to identify the age of the compliance result and will help ensure that age of the compliance result is known when being subsequently applied to a second policy.

As mentioned previously, input data is input into the compliance checks 205 to produce compliance results 207. For example, input data 202 is input into compliance check 205A to produce compliance result 207A. These compliance results 207 are then provided to a combine module 210 of the computing system. Combine module 210 may be any combiner capable of combining two or more values into a single value. It may be implemented in software, computer hardware, or any combination of the two. Combine module 210 is configured to take a single compliance check and its associated arguments, for example compliance check 205A and arguments 206, and combine them to create a unique identifier, such as unique identifier 215, that represents the combination of the compliance check and its associated arguments. The unique identifier 215 may be a hash value of the combination of the compliance check 205A and arguments 206. The unique identifier 215 may also be a concatenation of compliance check 205A and arguments 206. Finally, unique identifier 215 may be an expression of logical relationship between compliance check 205A and arguments 206. For example, the unique identifier incorporates the use of one or more pointers to associate the compliance check with a location of the associated arguments.

The unique identifier 215, representing the combination of compliance check 205A and arguments 206 is provided to an associate module 220. Associate module 220 may be implemented in software, computer hardware, or any combination of the two and is configured to associate two or more values. In this case, associate module 220 makes an association 225 between unique identifier 215, representing the combination of compliance check 205A and arguments 206, and the compliance result corresponding to the compliance check 205A, which is compliance result 207A. As previously described, compliance result 207A may also include a time component 209 that may be used to identify the age of the compliance result. Association 225 can be stored in the memory of the computing system containing the first policy checks for later application to a second policy as will be explained in further detail.

Referring again to FIG. 2, a second policy 230 is illustrated. The second policy 230 may be one of HIPAA, GLBA, FISMA, Sarbannes-Oxley or any other desired policy. The second policy 230 also includes a plurality of compliance checks and their associated arguments, which may also functionally operate to apply compliance checks in the context of associated arguments, and receive input data to thereby generate compliance results. For example, second policy 230 includes compliance checks 231A, 231B, 231C, 231D, and potentially any number of additional compliance checks as illustrated by ellipses 231E. The second policy 230 also includes arguments 233, which are associated with compliance check 231A. The remaining compliance checks 231 also have associated arguments that are not illustrated in FIG. 2. The second policy 230 with its compliance checks and associated arguments can be on the same computing system as the first policy 201 or both policies may be on different computing systems that are connected by a network such as the internet or a local area network.

In many instances, second policy 230, while being a different policy from first policy 201, will have one or more compliance checks and associated arguments that are the same as a compliance check and its associated arguments of the first policy 201. For example, as described previously, the first policy 201 may have a compliance check 205A and associated argument 206 that verify compliance to the minimum password length. The second policy 230 may have a compliance check 231A and associated argument 233 that also verify compliance to a minimum password length that is the same minimum password length as the first policy. In other words, the acceptable minimum password length specified by arguments 206 and 233 is the same. In this case, the principles of the present invention allow for the compliance result (i.e., compliance result 207A) produced for the first policy to be applied to the second policy 230 without having to run the compliance check of the second policy as will now be described.

For example, an input data 235 may be a password that is the same as the input data 202 password previously discussed. The input data for the second policy should be consistent with the input data from the first policy, at least to the extent that the input should be expected to generate the same compliance results based on the same compliance check and argument, in order for the compliance results of the first policy to be applied to the second policy. If the input data is not consistent, then the compliance result of the first policy is not applied to the second policy.

If the input data is estimated to be consistent (either by looking at the input data itself, or by examining the age of the results), then instead of running an additional compliance check operation, the identities of the compliance check 231A and argument 233 are used by a compare module 240. Compare module 240 may be any comparator capable of comparing two or more values. It may be implemented in software, computer hardware, or any combination of the two. Furthermore, compare module 240 may be part of either the computing system containing first policy 201 or the computing system containing the second policy 230 in embodiments where the two policies are on different computing systems.

In addition, compare module 240 is also provided with access to association 225, which comprises the association of unique identifier 215, which represents the combination of compliance check 205A and arguments 206, and compliance result 207A, which may include a time component 209, as previously discussed. Compare module 240 compares the compliance check 231A and argument 233 with compliance check 205A and argument 206 in order to ascertain if the compliance checks and associated arguments are the same. If compare module 240 ascertains that the compliance results and associated arguments are not the same, then the compliance result from the first policy 201 cannot be applied to the second policy 230. If, on the other hand, compare module 240 ascertains that the compliance checks and associated arguments are the same, then the compliance check 23 1A and associated argument 233 are provided to an apply module 250.

Apply module 250 may be implemented in software, computer hardware, or any combination of the two. Apply module 250 is configured to apply the compliance results of the first policy to the second policy when the compliance checks and associated arguments of the two policies exactly match. For example, apply module 250 will apply compliance result 207A to second policy 230. Advantageously, the compliance result of the first policy is utilized by the second policy without having to run a compliance check of the second policy, thus saving valuable computing resources.

In some embodiments, apply module 250 may be configured to analyze the time component of compliance result 207A. This allows apply module 250 to ascertain if the compliance result 207A was produced within an acceptable time period. For example, using the password length example previously discussed, if passwords for a particular policy were routinely changed every week and the time component 209 indicated that compliance result 207A was two weeks old, then apply module 250 would know not to apply the compliance result to the second policy. In other embodiments, other components of the computing system may be utilized to analyze the time component of the compliance result in the manner described.

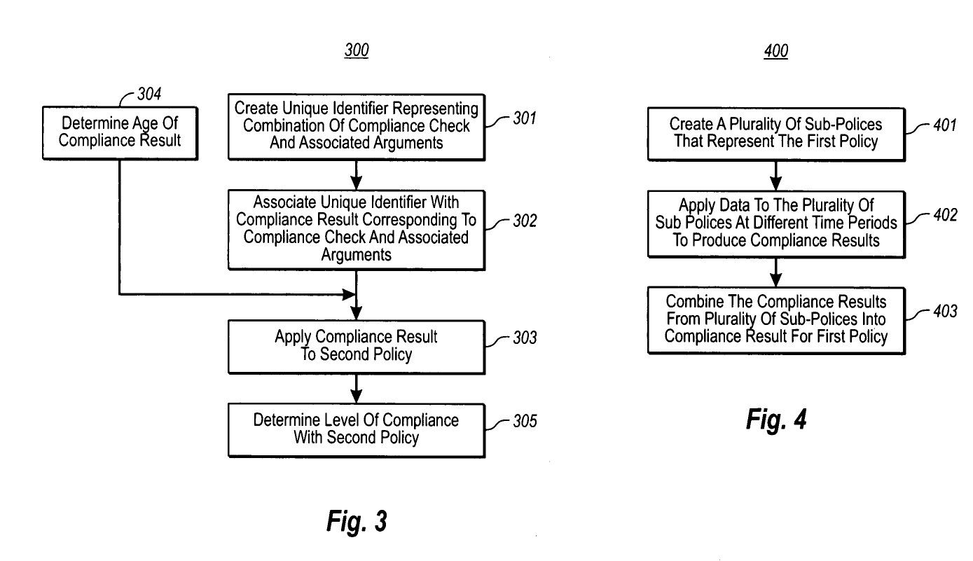

Turning now to FIG. 3, a flowchart of a method 300 for compliance results from at least a portion of a first policy to be applied to one or more additional policies that are different from the first policy is illustrated. Method 300 will be described with frequent reference to the schematic discussed in relation to FIG. 2. However, it should be noted that the steps of schematic 200 are only one of numerous ways to perform method 300 and should not be used to limit the scope of the appended claims.

Method 300 includes an act of creating a unique identifier representing a combination of both a compliance check and its associated arguments of the first policy (act 301). For example, combine module 210 can take compliance check 205A and associated argument 206 and combine them to create a unique identifier 215, which represents the combination of the compliance check and the argument.

Referring to FIG. 6, a more particular method 600 for creating a unique identifier is shown and will be illustrated with respect to FIG. 2. Acts 601 and 602 of the method 600 may correspond to act 301 of method 300 of FIG. 3, while act 603 may correspond to act 303, although this is not required. Method 600 includes an act of subjecting data to a plurality of compliance checks to produce compliance results (act 601). For example, input data 202 can be can be subjected to compliance check 205A to produce compliance results 207A. For instance, if input data 202 is a password and compliance check 205A and associated argument 206 verify allowed password length, then subjecting the password input data 202 to compliance check 205A will produce a compliance result 207A that indicates if the password is an allowable length.

Method 600 also includes an act of combining a compliance check and its associated argument(s) to generate a single integrated data structure representing a unique identifier that represents the combination of the compliance check and its associated arguments (act 602). For example, combine module 210 can combine compliance check 205A and arguments 206 to create a single integrated data structure representing unique identifier 215. For instance, the single integrated data structure representing unique identifier 215 may be a hash value of the combination of the compliance check 205A and arguments 206. The single integrated data structure representing unique identifier 215 may also be a concatenation of compliance check 205A and arguments 206. Finally, the single integrated data structure representing unique identifier 215 that may represent a logical relationship of compliance check 205A and arguments 206, as previously described.

Method 600 further includes an act of associating the unique identifier with the compliance result corresponding to the compliance check and its associated arguments comprising the unique identifier (act 603). For example, the associate module 220 can take unique identifier 215, which represents the combination of compliance check 205A and argument 206, and associates the combination with the compliance result 207A. The resulting association 225 may then be stored for later application to a different policy, for example second policy 230.

Returning now to FIG. 3, method 300 also includes an act of associating the unique identifier with the compliance result corresponding to the compliance check and its associated arguments comprising the unique identifier (act 302). This may be performed as described above for act 603 of method 600.

Method 300 further includes an act of applying the compliance result associated with the unique identifier to a second policy when a compliance check and its associated arguments of the second policy match the compliance check and its associated arguments representing the unique identifier (act 303). For example, compare module 240 can ascertain if compliance check 23 1A and argument 233 match the compliance check and arguments represented by unique identifier 215. Apply module 250 can then apply compliance result 207A to compliance check 231A and argument 233. For instance, if compliance check 207A is a compliance check for a minimum number of characters for a password and argument 206 specifies the minimum number of characters as explained, then if compliance check 231A is a compliance check for a minimum number of characters for a password and argument 233 specifies the minimum number of characters, compliance result 207A can be applied. In this way, the compliance result is applied to the second policy without having to run a compliance check for the second policy.

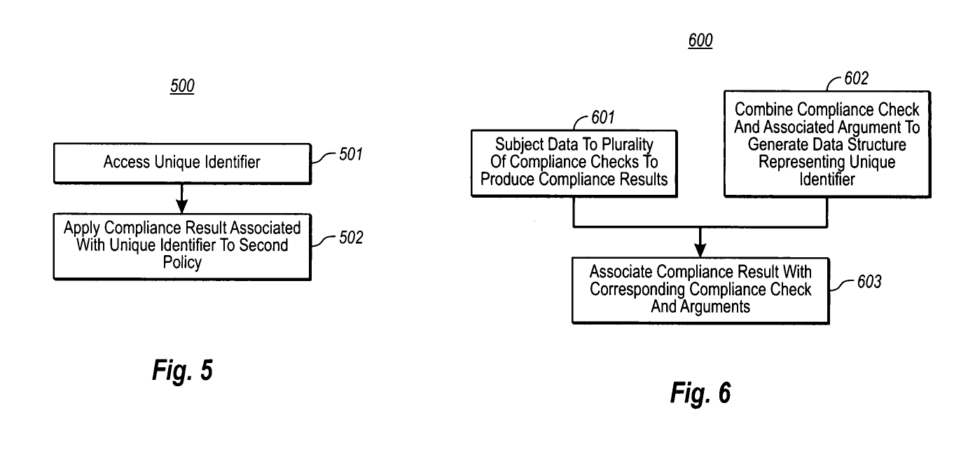

Turning now to FIG. 5, a flowchart of a more particular method 500 for a second policy to apply compliance results from at least a portion of a first policy is illustrated. Method 500 will be described with frequent reference to the schematic discussed in relation to FIG. 2. However, it should be noted that the steps of schematic 200 are only one of numerous ways to perform method 500 and should not be used to limit the scope of the appended claims.

Method 500 includes an act of accessing a unique identifier comprising both a compliance check and its associated arguments of the first policy, wherein the unique identifier is associated with a compliance result that has previously been determined (act 501). For example, the second policy 230 can access association 225 consisting of unique identifier 215 and compliance result 207A and provide the association 225 to compare module 240. As described previously, compliance result 207A and unique identifier 215 logically are determined prior to their being accessed by second policy 230. The association 225 can be stored and accessed from a memory location of a computing system containing both the first and second policies 201 and 230 in some embodiments. In other embodiments, where the second policy 230 is verified on a separate computing system from the first policy 201, the association 225 can be stored and accessed from a memory location of the computing system containing the first policy 201 or alternatively, the association 225 can be stored and accessed from a memory location of the computing system containing the second policy 230.

Method 500 also includes an act of applying the compliance result associated with the unique identifier to the second policy when a compliance check and its associated arguments of the second policy match the compliance check and its associated arguments comprising the unique identifier (act 502). For example, after having accessed the unique identifier 215, the second policy 230 can utilize apply module 250 to apply compliance result 207A, which is the compliance result associated with unique identifier 215 to the second policy 230. For embodiments where both the first policy 201 and the second policy 230 are verified on the same computing system, the act of applying is performed by that computing system (i.e., apply module 250 is contained in the computing system containing both the policies). On the other hand, in embodiments where the second policy 230 is on a different computing system than the first policy 201, the act of applying can be performed by the second computing system or the first computing system (i.e., apply module 250 can be contained in either the first or second computing system).

Returning now to FIG. 3, method 300 may include an act of determining the age of the compliance result associated with the unique identifier (act 304). For example, timing module 208 can apply a time component 209 that specifies the age of the compliance result to compliance result 207A. The time component 209 may be a data structure that is added to the code comprising compliance result 207A. The time component 209 can be analyzed by apply module 250 or some other computing system module or component to determine the age of the compliance result. If the compliance result is outdated (i.e., there has been a sufficiently long period of time since the compliance result was produced, such that the compliance result is no longer reliable), then this may be indicated to the computing system. As indicated in FIG. 3, the act of determining the age of the compliance result may happen prior to applying the compliance result to the second policy. This helps ensure that an outdated compliance result is not applied to the second policy.

Method 300 may also include an act of determining a level of compliance with the second policy based on the compliance result applied to the second policy (act 305). For example, in some embodiments the level of compliance may be specified as a percentage of compliance with the second policy. A report generator (not illustrated in FIG. 2) may take the compliance result applied to the second policy and return the percentage that the second policy complies with the compliance result. For example, suppose the compliance result specified the names of ten individuals who could have access to records. A compliance check and associated arguments of the second policy could be configured to check for individuals having allowed access. When the compliance result was applied to the second policy, the result generator could specify, for example, that the second policy was only 90% compliant as of the ten people allowed access to the records, only nine should have been allowed access.

In other embodiments, the level of compliance may be specified as a score that is judged against a predetermined value. For example, using the example above, if the result generator found that out of ten people allowed access to the records, only nine should have been allowed, then the result generator may give the result a score. This score would then be judged against a predetermined value. For instance, allowing access to one unauthorized person may receive a score of five, indicating an unacceptable level of compliance or an acceptable level of compliance depending on the predetermined value.

Referring to FIG. 4, a method 400 for using a number of sub-policies to determine a main first policy is illustrated. This method is useful for users who wish to run some parts of a policy at more frequent intervals than other parts of the policy in order to save computing resources and time.

Method 400 includes an act of creating a plurality of sub-policies that together represent the first policy, each sub-policy consisting of one or more compliance checks and associated arguments (act 401). For example, a HIPAA policy could be sub-divided into a number of smaller sub-polices that each consist of one or more compliance checks and associated arguments. The HIPAA policy could be divided into a sub-policy that checks for verification of a minimum password length and a sub-policy that checks for verification of the names of individuals who are allowed access to confidential medical records.

Method 400 further includes an act of applying data to each of the compliance checks of the plurality of sub-policies at different time periods in order to produce compliance results, the time periods being determined by the type of data applied to the compliance checks (act 402). For instance, in the HIPAA policy example, it may be desirable to run a compliance check on the minimum password length weekly or even daily as passwords are frequently changed by computing system users. On the other hand, the names of individuals with authorized access to secure medical records may only change infrequently, and therefore would only warrant the running of a compliance check on a monthly basis or longer to save on computing resources. The compliance results for both sub-policies may be obtained according to the method described with respect to FIG. 3, although this is not required.

Method 400 also includes an act of combining the compliance results from the plurality of sub-polices into a compliance result for the first policy (act 403). For instance, using the HIPAA example, the compliance results of both the password length sub-policy and the names of individuals with authorized access sub-policy can be combined into a compliance result for the entire HIPAA policy when verification of the entire policy is necessary.

Accordingly, the principles of the present invention relate to the application of compliance results from at least a portion of one policy to one or more additional policies that are different from the first policy without having to run compliance checks for the one or more additional policies. This allows for a compliance result to be shared across multiple policies, thus saving on computing resources that otherwise would be needed to run the compliance check for all the multiple polices. This may result in the saving of time and money. Accordingly, the principles of the present invention represent a significant advancement in the field of compliance software.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for implementing a method for compliance results from at least a portion of a first policy to be applied to one or more additional policies that are different from the first policy, wherein a policy is a plurality of compliance checks, each compliance check having associated one or more arguments that specify compliance conditions, the compliance checks producing compliance results indicative of compliance with the policy, and wherein subjecting data to the plurality of compliance checks of the first policy produces compliance results corresponding to each compliance check and its associated arguments, the computer program product comprising one or more computer-readable media having thereon computer-executable instructions that, when executed by one or more processors of the computing system, cause the computing system to perform the method, the method comprising:
an act of creating a unique identifier representing a combination of both a compliance check and its associated arguments of the first policy;
an act of associating the unique identifier with the compliance result corresponding to the compliance check and its associated arguments comprising the unique identifier; and
an act of applying the compliance result associated with the unique identifier to a second policy when a compliance check and its associated arguments of the second policy match the compliance check and its associated arguments representing the unique identifier.

2. A computer program product in accordance with claim 1 further comprising:
an act of determining the age of the compliance result associated with the unique identifier.

3. A computer program product in accordance with claim 1 further comprising:
an act of determining a level of compliance with the second policy based on the compliance result applied to the second policy.

4. A computer program product in accordance with claim 3, wherein the level of compliance is specified as a percentage of compliance with the second policy.

5. A computer program product in accordance with claim 3, wherein the level of compliance is specified as a score that is judged against a predetermined value.

6. A computer program product in accordance with claim 1 further comprising:
an act of creating a plurality of sub-policies that together represent the first policy, each sub-policy consisting of one or more compliance checks and associated arguments;
an act of applying data to the one or more compliance checks of the plurality of sub-policies at different time periods in order to produce compliance results, the time periods being determined by the type of data applied to the one or more compliance checks; and
an act of combining the compliance results from the plurality of sub-polices into a compliance result for the first policy.

7. A computer program product in accordance with claim 1, wherein the first and second policies are one of HIPAA, FISMA, GLBA, or Sarbanes-Oxley.

8. A computer program product in accordance with claim 1, wherein the one or more computer-readable media are physical memory media.

9. In a computing system including at least two policies, wherein a policy is a plurality of compliance checks, each compliance check having associated one or more arguments that specify compliance conditions, the compliance checks producing compliance results indicative of compliance with the policy, a method for compliance results from at least a portion of a first policy to be applied to one or more additional policies that are different from the first policy, wherein subjecting data to the plurality of compliance checks of the first policy produces compliance results corresponding to each compliance check and its associated arguments, the method comprising:
an act of creating a unique identifier representing a combination of both a compliance check and its associated arguments of the first policy;
an act of associating the unique identifier with the compliance result corresponding to the compliance check and its associated arguments comprising the unique identifier; and
an act of applying the compliance result associated with the unique identifier to a second policy when a compliance check and its associated arguments of the second policy match the compliance check and its associated arguments representing the unique identifier.

10. A method in accordance with claim 9 further comprising:
an act of determining the age of the compliance result associated with the unique identifier.

11. A method in accordance with claim 9, wherein the first and second policies are one of HIPAA, FISMA, GLBA, or Sarbanes-Oxley.

12. A computer program product for implementing a method for a second policy to apply compliance results from at least a portion of a first policy, wherein a policy is a plurality of compliance checks, each compliance check having associated one or more arguments that specify compliance conditions, the compliance checks producing compliance results indicative of compliance with the policy, the computer program product comprising one or more computer-readable media having thereon computer-executable instructions that, when executed by one or more processors of the computing system, cause the computing system to perform the method, the method comprising:
an act of accessing a unique identifier comprising both a compliance check and its associated arguments of the first policy, wherein the unique identifier is associated with a compliance result that has previously been determined; and
an act of applying the compliance result associated with the unique identifier to the second policy when a compliance check-and its associated arguments of the second policy match the compliance check and its associated arguments comprising the unique identifier.

13. A computer program product in accordance in claim 12, wherein the act of accessing is performed by a second computing system accessing the unique identifier from a first computing system over a network, and wherein the act of applying is performed by the second computing system.

14. A computer program product in accordance with claim 12, wherein the act of accessing occurs from a location within the computing system.

15. A computer program product in accordance with claim 12, wherein the one or more computer-readable media are physical memory media.

16. A computer program product for implementing a method for creating a unique identifier for a policy, wherein a policy is a plurality of compliance checks, each compliance check having associated one or more arguments that specify compliance conditions, the compliance checks producing compliance results indicative of compliance with the policy, the computer program product comprising one or more computer-readable media having thereon computer-executable instructions that, when executed by one or more processors of the computing system, cause the computing system to perform the method, the method comprising:
an act of subjecting data to the plurality of compliance checks of the policy to produce compliance results corresponding to each compliance check and its associated arguments;
an act of combining one of the plurality of compliance checks and its associated arguments to generate a single integrated data structure representing a unique identifier that represents the combination of the compliance check and its associated arguments; and
an act of associating the unique identifier with the compliance result corresponding to the compliance check and its associated arguments comprising the unique identifier.

17. A computer program product in accordance with claim 16, wherein the single integrated data structure representing a unique identifier is a hash value of the combination of the compliance check and its associated arguments.

18. A computer program product in accordance with claim 16, wherein the single integrated data structure representing a unique identifier is a concatenation of the compliance check and its associated arguments.

19. A computer program product in accordance with claim 16, wherein the single integrated data structure representing a unique identifier is a logical relationship of the compliance check and its associated arguments.

20. A computer program product in accordance with claim 16, wherein the one or more computer-readable media are physical memory media.
